(19) United States
(12) Patent Application Publication
(10) Pub. No.: US 2004/0223198 A1
(43) Pub. Date: Nov. 11, 2004

(54) Security and authentication marking of products

(76) Inventors: Bruce Lawence John Murray, East Sussex (GB); William Nevil Heaton Johnson, St.Peter Port (GB)

Correspondence Address: CLIFFORD A. POFF, 9800B MCKNIGHT ROAD, SUITE 115, PITTSBURGH, PA, 15237, US

(21) Appl. No.: 10/765,411

(22) Filed: Jan. 26, 2004

(30) Foreign Application Priority Data
Jul. 26, 2001 (GB) 0118382.1

(51) Int. Cl. G03H 1/00

(52) U.S. Cl. 359/1

(57) ABSTRACT

In a system for security marking a product, a surface of the product 10 is covered by a layer 14 of light-transmitting material which exhibits variations in refractive index throughout the material such that for most angles of view the material acts as a conventional diffuser of light and thereby conceals or obscures a marking 12 applied to a surface of the product and covered by layer 14, but for a critical angle of view, or a limited range of angles close to that critical angle, the layer is effectively transparent allowing unimpeded viewing of the marking. In a variant, the marking is itself incorporated in the layer in the form of refractive index variations in the layer. The layer 14 is provided by applying to the product, for example over a conventional printed marking, a coating of a photopolymerisable material and causing said material to polymerise, by appropriate exposure to collimated ultraviolet light at a predetermined angle of incidence, to establish the desired refractive index variations within the layer.

THIS INVENTION relates to the provision of marking upon products, e.g. CDs, DVDs, and CD ROMS in such a way that purchasers may be assured of their authenticity and may check, for example, that they are not illicit copies.

According to one aspect of the invention, there is provided a system for security marking products, in which a marking is applied to a surface of the product and is covered by a layer of light-transmitting material which exhibits variations in refractive index throughout the material such that for most angles of view the material acts as a conventional diffuser of light and thereby conceals or obscures the marking, but for a critical angle of view, or a limited range of angles close to that critical angle, the layer is effectively transparent allowing unimpeded viewing of the marking.

According to another aspect of the invention, the system according to the previous aspect is modified in that instead of (or as well as) an opaque marking being applied to said surface of the product before application of the graded refractive index layer, the marking is itself constituted by refractive index variations within the layer, such that for most angles of view, the graded refractive index layer presents the appearance of a uniform light-diffusing coating.

WO/0239183; WO/0239184; and WO/0239185, the contents of which are incorporated herein by reference, disclose silicone-based photopolymerisable materials which can be caused to polymerise, by appropriate exposure to appropriate radiation, (e.g. ultraviolet light) and which can be caused, e.g. by exposure to collimated radiation at certain critical angles, to function in the manner of the graded refractive index layers referred to above. The inventors have found that other photopolymerisable materials can also be similarly caused to act in a similar way.

In some embodiments of the invention, the security or authentication marking may comprise an opaque marking, for example printed on the article concerned, and an overlying layer or coating of the graded refractive index material, the latter being so arranged that when the marked surface of the article is viewed, from most angles of view the overlying layer or coating is effectively opaque as a result of its light-diffusing properties, and thus conceals the printed marking, but is transparent from the critical angle of view, (and generally also from a narrow range of angles of view near to the critical angle of view) so that the printed marking can be viewed through the overlying coating.

In other embodiments, the security or authentication marking may be incorporated in the graded refractive index material itself, for example, by arranging that selected regions of the material (for example defining characters, numbers, or a “bar-code” marking), are light-diffusing, and are substantially opaque at all angles of view, or are transparent from a different angle of view from the angle of view for which the remainder of the graded refractive index material becomes transparent, so that they become visible at the critical angle of view for which the remainder of the material (e.g. forming the “background” to the marking) becomes transparent. Of course, the reverse arrangement may also be used, i.e. the “background” areas of the graded refractive index material may be light-diffusing, and thus effectively opaque, from all angles of view, with only selected regions, defining characters, numbers, or a bar-code being transparent at a critical angle of view and light-diffusing, and thus effectively opaque, from other angles of view, in such a way as to be indistinguishable from the “background” areas.

Embodiments of the invention are described below, by way of example, with reference to the accompanying drawings, in which:

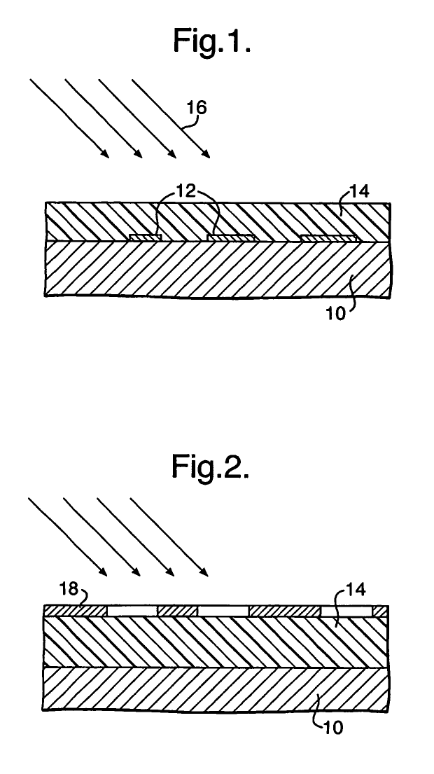

FIG. 1 is a schematic sectional view illustrating how one form of security marking embodying the invention may be produced; and

FIG. 2 is a view similar go FIG. 1 but showing how another form of security marking in accordance with the invention may be produced.

Referring to FIG. 1 a substrate 10 provided by a product (e.g. a part of a CD or CD ROM not carrying the recording or data which forms the purpose of the product) has authentication marking 12, for example in the form of text, a serial number or a bar-code, applied thereto by a conventional printing technique.

Over the printed substrate is applied a layer 14 of a photopolymerisable material, such as disclosed in WO/0239183; WO/0239184; and WO/0239185. The latter material is in the form of a viscous liquid prior to polymerisation and can be applied like a coat of varnish. The layer 14 is then polymerised by exposure to collimated (i.e. substantially in a parallel beam) UV light, as indicated at 16, directed onto the layer 16 at a predetermined angle with respect to the coated surface (or with respect to the normal to that surface), to bring about polymerisation of layer 14. The inventor has discovered that by following such an exposure regime, the coating 14 can be converted to a tough, solid layer which acts as a diffuser of light and has the appearance, from most angles of view, of a diffuse, milky or translucent coating, but which appears entirely transparent when viewed from a particular angle of view, herein referred to as the critical angle, which depends upon (and generally corresponds to) the angle at which the radiation 16 was directed onto the coating 14 to polymerise it.

Whilst the inventor has found that, with the material disclosed in WO/0239183; WO/0239184; and WO/0239185, the exposure regime depicted in FIG. 1 will work, in order to afford better control of the extent to which the coating will diffuse light, and thus of the extent to which the coating 14 approximates, for most angles of view, to an opaque coating, the layer 14 can be exposed through an optical mask, as indicated at 18, for example a speckle mask, as referred to in WO/0239183; WO/0239184; and WO/0239185.

In a refinement of this variant, illustrated in FIG. 2, the printed marking 12 is dispensed with and the authentication marking (text, numbers, or whatever) is defined by totally opaque portions of such mask, and after a main exposure to UV light from one angle, the mask 18 is removed and the layer 14 exposed to UV light from another direction to polymerise the regions previously under the totally opaque parts of the mask, so that in the finished product, from most angles of view the coating will appear uniformly diffusive, e.g. grey or white, from one critical angle of view, the marking will appear as diffusive (white or grey) against a transparent background, and from another critical angle of view the marking will appear as transparent against a diffusive (white or grey) background.

In a simpler arrangement, the photopolymer layer may be exposed uniformly to UV light of the same angle of incidence, and the text, numerals, bar-code, or the like of the marking may be impressed on the material or on a transparent substrate in such a way as to provide a light diffusing surface indistinguishable from the general light diffusing area provided by the photopolymer except at the critical angle of view at which the non-impressed areas of the photopolymer become transparent

In application of the invention to CDs or CD-ROMS, these are routinely provided with a protective, transparent coating and it is envisaged that this might be replaced by a photopolymer layer such as layer 14, at least over the regions not requiring to be “read” by the laser optics of the CD reader.

The described effect of the photopolymerised layer is believed (although the applicants do not wish to be bound to this hypothesis) to be due to the forming of so-called light-pipes (akin in action to optical fibres) in the photopolymerisable material, aligned along the direction of incidence of the polymerising light. It is conjectured that the switching from light diffusing action to transparency is analogous to the Bragg effect encountered in X-ray crystallography.

As discussed above, according to the applicants' hypothesis, in the systems of the present invention, light pipes are created using graded refractive index effects in a photopolymer film, under circumstances such as to cause an effect by which, at certain angles of view, the diffusion switches off and the film becomes clear.

In some embodiments of the invention, the critical angle of view may be normal (perpendicular) to the plane of the surface to which the marking is applied and the text numerals, bar-code or the like in the marking may be arranged to become visible by becoming light diffusing before of after the “background” area of the marking.

The materials disclosed in WO/0239183; WO/0239184 and WO/0239185 can be formulated to create the above-noted effect without using masks and so would be ideal as a security label material.

Thus, embodiments of the invention may provide an area or coating of a label, marking, or the like that has a light-diffusing property that “switches off” to become transparent as the angle of view changes in order to provide an overt feature for validation of authenticity. A batch number or other information or design may be impressed into the transparent area so that either it remains diffuse at all times even where the remainder of the area or coating appears transparent, or remains transparent or clear at all times even where the remainder of the area or coating appears diffuse, in each case providing a form of “watermark”. Such a product may be formed by the use of a shadow mask or by the use of impression, or radiation of an appropriate wavelength.

Where there is a clear area of any product, for example a CD, DVD, CDROM or similar recording medium where the central zone can be clear, then a label as described above can be provided over that clear area or over an area where material can be deposited and then processed to provide the required effects.

It is possible to provide a label on a product or product with a transparent area as described above which is provided with other packaging of some sort whereby the required angle for transparency can be checked by folding the label or, in the case of a CD, opening the jewel case and resting the CD on the central securing hub and checking the point on the lid where the CD rests when the area becomes transparent. Instead of having a transparent area, a reflective surface may be used and the effects described above can be observed in reflection.

Using a suitable material, such as disclosed in WO/0239183; WO/0239184; and WO/0239185, and ink-jet technology, the optically variable material (photopolymerisable material) may be printed onto either a reflective or transparent label or onto a reflective or transparent area of a product and then processed to create a printed message or design or texture that is only visible at certain angles of view.

Instead of processing the material so that light pipes are created within the volume of the material Lippmann layers may be created using laser light so that the print is composed of highly reflective coloured dots. As the colour of the dots, using Lippmann layers depends upon the thickness of the layer the colours produced will change if heated. This can be used as a test of authenticity.

In the present specification “comprises” means “includes or consists of” and “comprising” means “including or consisting of”.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilised for realising the invention in diverse forms thereof.

1. A system for security marking a product, in which a surface of the product is covered by a layer of light-transmitting material which exhibits variations in refractive index throughout the material such that for most angles of view the material acts as a conventional diffuser of light and thereby conceals or obscures a marking applied to a surface of the product and covered by said layer, or conceals or obscures a marking incorporated in said layer, but for a critical angle of view, or a limited range of angles close to that critical angle, the layer is effectively transparent allowing unimpeded viewing of the marking.

2. A system according to claim 1 in which the marking is itself constituted by refractive index variations within the layer, such that for most angles of view, the graded refractive index layer presents the appearance of a uniform light-diffusing coating.

3. A system according to claim 1 or claim 2 wherein said layer of light transmitting material has been formed by exposing a photopolymerisable material to polymerising radiation.

4. A security or authentication marking which comprises an opaque marking, for example printed on the article concerned, and an overlying layer or coating of a graded refractive index material, the latter being so arranged that when the marked surface of the article is viewed, from most angles of view the overlying layer or coating is effectively opaque as a result of its light-diffusing properties, and thus conceals the printed marking, but is transparent from the critical angle of view, so that the printed marking can be viewed through the overlying coating.

5. A product having a security or authentication marking, and wherein the product comprises a layer or coating of a graded refractive index material and in which the security or authentication marking is incorporated in the graded refractive index material itself, for example, by arranging that selected regions of the material are light-diffusing, and are substantially opaque at all angles of view, or are transparent from a different angle of view from the angle of view for which the remainder of the graded refractive index material becomes transparent, so that they become visible at the critical angle of view for which the remainder of the material becomes transparent.

6. A marking system according to any preceding claim in which, instead of processing the material so that light pipes are created within the volume of the material, Lippmann layers are created using laser light so that the marking is composed of highly reflective coloured dots.

7. A method of providing a security marking on a product, comprising applying to the product a coating of a photopolymerisable material and causing said material to polymerise, by appropriate exposure to appropriate collimated radiation, (e.g. collimated ultraviolet light), at a predetermined angle, to establish refractive index variations within the layer, such that for most angles of view, the graded refractive index layer presents the appearance of a uniform light-diffusing coating, but for a critical angle of view, or a limited range of angles close to that critical angle, the layer is effectively transparent allowing unimpeded viewing of the marking.
